(19) United States
(12) Patent Application Publication
(10) Pub. No.: US 2026/0290263 A1
(43) Pub. Date: Sep. 24, 2026

(54) METHOD FOR COLOR COMPENSATION IN MULTI-COLOR BACKLIGHT DISPLAY DEVICE AND MULTI-COLOR BACKLIGHT DISPLAY DEVICE

(71) Applicant: MEDIATEK INC., Hsinchu City (TW)

(72) Inventors: Kuo-Chen HUANG, Hsinchu City (TW); Wei-Ting HUANG, Hsinchu City (TW); Shih-Heng TSAI, Hsinchu City (TW); Chun-Kang PENG, Hsinchu City (TW); Ruei-Jyun CHANG, Hsinchu City (TW); Kai-Chen WANG, Hsinchu City (TW); Wen-Huei LO, Hsinchu City (TW)

(21) Appl. No.: 19/570,671

(22) Filed: Mar. 18, 2026

Related U.S. Application Data
(60) Provisional application No. 63/776,356, filed on Mar. 24, 2025.

(51) Int. Cl. G09G 3/34

(52) U.S. Cl. CPC G09G 3/3413; G09G 2320/0242; G09G 2360/16

(57) ABSTRACT

A method for color compensation in a multi-color backlight display device is provided. The display device includes a display device and a backlight module, the backlight module includes a plurality of light-emitting channels and the display panel has a plurality of light modulation units. The method includes obtaining a reference color gamut of the display device. The method includes receiving input image data containing original color information of a plurality of pixels. The method includes calculating a current per-pixel gamut for each pixel based on an effective backlight color received by each pixel, wherein the effective backlight color corresponds to driving values of the plurality of light-emitting channels. The method includes performing a pixel compensation operation on the plurality of pixels based on the current per-pixel gamut.

### CROSS REFERENCE TO RELATED APPLICATIONS

This application claims the benefit of U.S. Provisional Application No. 63/776,356, entitled “Multi-Color Backlight Compensation”, filed on Mar. 24, 2025, the entirety of which is incorporated by reference herein.

### BACKGROUND OF THE INVENTION

### Field of the Invention

The present disclosure generally relates to the field of display technology. More specifically, aspects of the present disclosure relate to a method for color compensation in a multi-color backlight display device, and a multi-color backlight display device having a plurality of light-emitting channels and a plurality of color filter channels.

### Description of the Related Art

Unless otherwise indicated herein, approaches described in this section are not prior art to the claims listed below and are not admitted as prior art by inclusion in this section.

Liquid-Crystal Displays (LCDs) are widely used in various electronic devices. A typical LCD apparatus includes a backlight module and a liquid-crystal panel. The liquid-crystal panel controls the transmittance of light through liquid-crystal molecules and utilizes color filters (e.g., Red, Green, and Blue) to generate color images.

Traditionally, backlight modules employ white light sources (such as White LEDs). In these systems, the color gamut is primarily determined by the spectral characteristics of the color filters. However, to achieve a wider color gamut and higher color saturation, advanced display technologies have begun to adopt multi-color backlight systems. For example, instead of a uniform white light, the backlight may utilize combinations of differently colored light sources (e.g., Red, Green, and Blue LEDs, or Blue and Yellow LEDs) to provide a tunable light source.

Furthermore, to improve contrast ratios and reduce power consumption, "Local Dimming" technology has been introduced. Local dimming allows the backlight module to be divided into a plurality of zones, where the brightness of each zone is individually controlled based on the image content. In a multi-color local dimming system, it is not just the brightness but also the color of the backlight in each zone that can be dynamically adjusted.

However, the implementation of multi-color local dimming introduces complex color reproduction challenges. In a multi-color backlight system, the color of the light incident on each pixel is not constant; it varies depending on the driving state of the backlight zones corresponding to that pixel. Consequently, the range of colors that a specific pixel can display changes dynamically.

A significant problem arises when the spatial resolution of the backlight is lower than that of the display panel. Light emitted from one backlight zone diffuses and affects neighboring pixels. This can lead to a "color shift" phenomenon, particularly in scenes featuring objects with high color contrast located near each other.

For example, consider a scenario where a bright red object is adjacent to a white object. The local dimming algorithm may drive the backlight behind the red object to emit high-intensity red light to maximize saturation. Due to light diffusion, the adjacent white object also receives this red-dominant backlight. If the mixed backlight color received by the pixels of the white object lacks sufficient energy in other color channels (e.g., blue or green), even with the LCD panel fully open, this light cannot be adjusted to produce a pure white color.

As illustrated in FIG. 1, when the current per-pixel gamut determined by the mixed backlight color does not encompass the target input data (e.g., the white color of a white object 110 located on a red shirt), the display device cannot reproduce the correct color. The target color falls outside the achievable gamut of that pixel at that moment, resulting in a visible color shift where the white object 110 in the visual result 120 appears reddish.

Therefore, there is a need for a method for color compensation in a multi-color backlight display device, as well as a multi-color backlight display device that may prevent color shift and ensuring accurate color reproduction.

### SUMMARY

The following summary is illustrative only and is not intended to be limiting in any way. That is, the following summary is provided to introduce concepts, highlights, benefits and advantages of the novel and non-obvious techniques described herein. Select, not all, implementations are described further in the detailed description below. Thus, the following summary is not intended to identify essential features of the claimed subject matter, nor is it intended for use in determining the scope of the claimed subject matter.

Therefore, the main purpose of the present disclosure is to provide a method for color compensation in a multi-color backlight display device, and a multi-color backlight display device. Specifically, the present disclosure utilizes color matrices to account for light leakage and dynamically estimates a per-pixel gamut. By cooperatively adjusting the backlight of target and adjacent regions to ensure sufficient color coverage and performing a precise gamut mapping operation, the method accurately restores the original input colors, thereby effectively eliminating color shift.

In an exemplary embodiment, a method for color compensation in a multi-color backlight display device is provided. The multi-color backlight display device comprises a display panel and a backlight module, the backlight module comprises a plurality of light-emitting channels, and the display panel has a plurality of light modulation units. The method includes obtaining a reference color gamut of the display panel. The method further includes receiving input image data containing original color information of a plurality of pixels. The method further includes calculating a current per-pixel gamut for each pixel based on an effective backlight color received by each pixel, wherein the effective backlight color corresponds to driving values of the plurality of light-emitting channels. The method further includes performing a pixel compensation operation on the plurality of pixels based on the current per-pixel gamut.

In some embodiments, the reference color gamut is obtained based on the plurality of light modulation units of the display panel being illuminated by the plurality of light-emitting channels of the backlight module.

In some embodiments, the pixel compensation operation is performed by mapping the original color information from the reference color gamut to the current per-pixel gamut.

In some embodiments, after calculating the current per-pixel gamut for each pixel based on the effective backlight color received by each pixel and before performing the pixel compensation operation, the method further comprises determining whether the effective backlight color enables the current per-pixel gamut for each pixel to cover the original color information of the plurality of pixels within the input image data and adjusting the driving values of the plurality of light-emitting channels when the effective backlight color fails to enable the current per-pixel gamut to cover the original color information.

In some embodiments, the step of adjusting the driving values of the plurality of light-emitting channels further comprises: collecting color statistics of a target region of the input image data; identifying the target region in which a target effective backlight color fails to enable the current per-pixel gamut to cover the original color information based on the color statistics; and adjusting the driving values corresponding to the target region and at least one adjacent region neighboring the target region.

In some embodiments, the method further comprises calculating an updated per-pixel gamut for the pixels within the target region based on the adjusted driving values of the plurality of light-emitting channels. The method further comprises performing the pixel compensation operation based on the updated per-pixel gamut.

In some embodiments, the step of calculating the current per-pixel gamut for each pixel comprises accumulating light intensities from the plurality of light-emitting channels on each pixel to obtain the effective backlight color for each pixel.

In some embodiments, after receiving input image data and before calculating the current per-pixel gamut for each pixel, the method further comprises analyzing color statistics of a target region of the input image data, and determining driving values for the plurality of light-emitting channels of the backlight module based on the color statistics, in order to enable the current per-pixel gamut for pixels in the target region to cover the original color information of the pixels within the region.

In some embodiments, each light modulation unit includes a corresponding color filter, and the display panel further comprises a plurality of color filter channels.

In some embodiments, the display device is a field sequential display (FSD), and the plurality of light-emitting channels are configured to emit different colors sequentially in time.

In an exemplary embodiment, a multi-color backlight display device is provided. The multi-color backlight display device comprises a display panel and a backlight module, wherein the backlight module comprises a plurality of light-emitting channels, and the display panel has a plurality of light modulation units. The multi-color backlight display device comprises a memory and at least one processor coupled to the memory. The processor performs the following operations. The processor performs operations comprising obtaining a reference color gamut of the display panel. The processor performs operations comprising receiving input image data containing original color information of a plurality of pixels. The processor performs operations comprising obtaining a reference color gamut of the display panel. The processor performs operations comprising performing a pixel compensation operation on the plurality of pixels based on the current per-pixel gamut.

### BRIEF DESCRIPTION OF THE DRAWINGS

The accompanying drawings are included to provide a further understanding of the present disclosure, and are incorporated in and constitute a part of the present disclosure. The drawings illustrate implementations of the disclosure and, together with the description, serve to explain the principles of the disclosure. It should be appreciated that the drawings are not necessarily to scale, as some components may be shown out of proportion to their size in actual implementation in order to clearly illustrate the concept of the present disclosure.

FIG. 1 is a schematic diagram illustrating a color shift problem occurring when a per-pixel gamut fails to encompass an input data point.

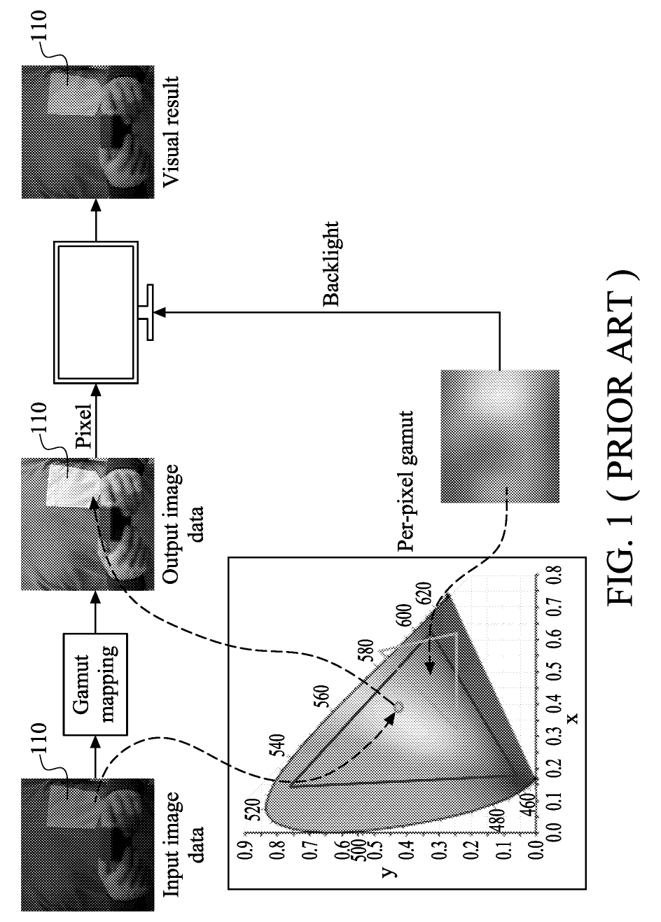

FIG. 2 is a flowchart illustrating a method for color compensation in a multi-color backlight display device in accordance with an implementation of the present disclosure.

FIG. 3 is a schematic diagram illustrating an operational example of mixed backlight color generation and gamut conversion in a backlight module comprising yellow and blue light-emitting channels in accordance with an implementation of the present disclosure.

FIG. 4 is a schematic diagram illustrating a gamut expansion example utilizing a Red-Green-Blue-Cyan (RGBC) backlight module and an RGB display panel according to an embodiment of the present disclosure.

FIG. 5 is a schematic diagram illustrating the process of backlight adjustment and pixel compensation based on color statistics according to an embodiment of the present disclosure.

FIG. 6 is a schematic diagram illustrating the measurement process and calculation of color matrices for quantifying backlight and filter characteristics according to an embodiment of the present disclosure.

FIG. 7 is a schematic diagram illustrating the gamut mapping process based on source data and backlight target data according to an embodiment of the present disclosure.

FIGS. 8A-8C are schematic diagrams illustrating a comparison of simulation results between a source image, an image processed by the proposed method for color compensation, and an image processed by a normal backlight compensation method in accordance with an implementation of the present disclosure.

FIGS. 9A-9C illustrate the effects achieved by applying the color compensation method in accordance with an implementation of the present disclosure.

FIG. 10 is a schematic structural diagram of a display device in accordance with the present disclosure.

### DETAILED DESCRIPTION OF THE INVENTION

The following description contains specific information pertaining to example implementations in the present disclosure. The drawings in the present disclosure and their accompanying detailed description are directed to merely example implementations. However, the present disclosure is not limited to merely these example implementations. Other variations and implementations of the present disclosure will occur to those skilled in the art. Unless noted otherwise, like or corresponding elements among the figures may be indicated by like or corresponding reference numerals. Moreover, the drawings and illustrations in the present disclosure are generally not to scale and are not intended to correspond to actual relative dimensions.

For consistency and ease of understanding, like features may be identified (although, in some examples, not shown) by the same numerals in the example figures. However, the features in different implementations may differ in other respects, and thus shall not be narrowly confined to what is shown in the figures.

The description uses the phrases “in one implementation” or “in some implementations,” which may each refer to one or more of the same or different implementations. The term “coupled” is defined as connected, whether directly or indirectly through intervening components, and is not necessarily limited to physical connections. The term “comprising,” when utilized, means “including, but not necessarily limited to”; it specifically indicates open-ended inclusion or membership in the so-described combination, group, series, and the equivalent. The expression “at least one of A, B, and C” or “at least one of the following: A, B, and C” means “only A, or only B, or only C, or any combination of A, B, and C.”

The solution proposed in the present disclosure may accurately estimate the actual per-pixel gamut resulting from the mixed backlight and dynamically adjust the backlight driving values to ensure the backlight gamut covers the input image data, thereby preventing color shift and ensuring accurate color reproduction.

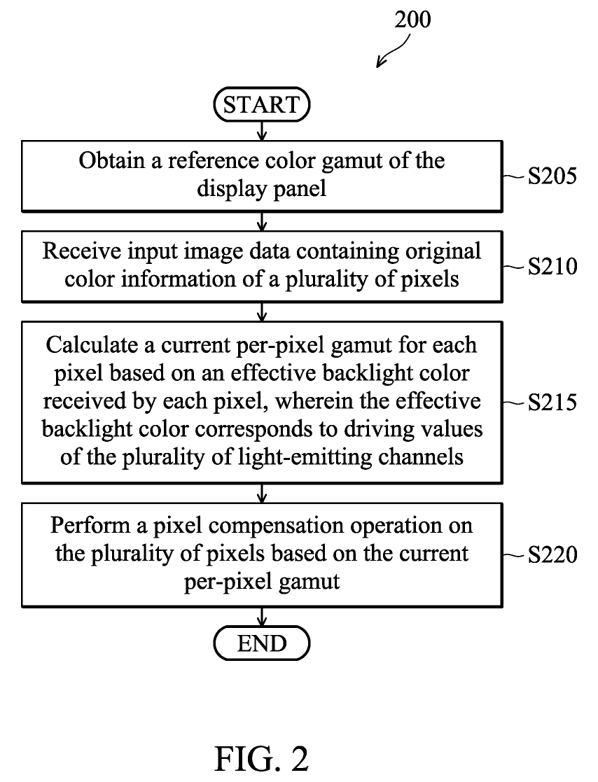

FIG. 2 is a flowchart illustrating a method 200 for color compensation in a multi-color backlight display device in accordance with an implementation of the present disclosure. In the method 200 for color compensation, the multi-color backlight display device comprises a display panel and a backlight module, wherein the backlight module comprises a plurality of light-emitting channels and the display panel has a plurality of light modulation units. The method 200 for color compensation may be implemented by a processor of a multi-color backlight display device or any suitable device. For the convenience of illustration and not by way of limitation, the processor of the multi-color backlight display device is taken as an example below to describe the method 200 for color compensation.

In various embodiments, the plurality of light modulation units in the display panel may be implemented using different technologies, depending on the architecture of the display device. For example, in a liquid crystal display (LCD) architecture, each light modulation unit typically comprises a liquid crystal cell and an associated color filter, and the display panel further comprises a plurality of color filter channels, such as red, green, and blue color filters arranged in a repeating sequence. In this structure, light modulation is achieved by controlling the transmittance of the liquid crystal cell, while the corresponding color filter selects the desired color component from the spatially mixed backlight. The combination of the liquid crystal cell and color filter in each light modulation unit enables the display of full-color images through additive color mixing.

In alternative embodiments, such as in a field sequential display (FSD) or field sequential color (FSC) architecture, each light modulation unit may be implemented as a liquid crystal cell or equivalent optical shutter without an integrated color filter, and the display panel does not include color filter channels. In this case, the display device is a field sequential display (FSD), and the plurality of light-emitting channels of the backlight module are configured to emit different colors sequentially in time. Color is achieved by temporally illuminating the light modulation units with distinct colored backlight fields, and the liquid crystal cells modulate the transmission of each colored field in synchronization with the field sequence, thereby synthesizing the desired color per pixel through temporal multiplexing.

Accordingly, the present disclosure broadly defines a light modulation unit as any controllable structure capable of modulating the passage of light for each pixel, and encompasses both implementations comprising color filters with corresponding color filter channels, as in conventional LCDs, and implementations without color filters, wherein the plurality of light-emitting channels are configured for temporal color sequencing, as in FSD architectures and similar advanced display technologies.

In step S205, the processor of the multi-color backlight display device obtains a reference color gamut of the display panel. In some implementations, the reference color gamut is obtained based on the plurality of light modulation units of the display panel being illuminated by the plurality of light-emitting channels of the backlight module. In various embodiments, the "reference color gamut" refers to a color space that is determined by the combined optical contribution of the plurality of light modulation units in the display panel when illuminated by the plurality of light-emitting channels of the backlight module. The reference color gamut may be established by measuring or calculating the range of colors that can be produced under specified operating conditions, which may include, but are not limited to, the maximum drive settings for each light-emitting channel or other preset combinations adopted for system optimization. In practical applications, the reference color gamut for rendering images on the display may be intentionally limited, either by system-level configuration, user preference, panel lifetime management, color profile requirements, or external system commands. For example, the display may be set to use only 90% of its maximum color gamut (such as restricting the color space coverage from 95% to 90% of BT.2020), to extend panel longevity, conserve energy, or comply with specific application requirements. As such, the method disclosed herein is applicable not only when the display operates at its physical color limits, but also when the color range is purposefully restricted or customized for specific use cases.

Then, in step S210, the processor receives input image data containing original color information of a plurality of pixels.

Next, in step S215, the processor calculates a current per-pixel gamut for each pixel based on an effective backlight color received by each pixel, wherein the effective backlight color corresponds to driving values of the plurality of light-emitting channels. In some implementations, the processor may calculate the effective backlight color actually received by each pixel based on the current driving state of the backlight module. Specifically, the driving state refers to the individual driving values applied to the plurality of light-emitting channels in the backlight module. The driving state may comprise brightness control parameters respectively corresponding to each of the light-emitting channels. The brightness control parameter may be, for example, a magnitude of a driving current.

For example, when the backlight module comprises four independent light-emitting channels: red, green, blue, and cyan, the driving state includes a red driving value, a green driving value, a blue driving value, and a cyan driving value. These driving values collectively determine a mixed spectral composition and luminous intensity emitted by the backlight module (or a specific local dimming zone thereof) at the current time point. The processor may calculate the light intensity contribution of each light-emitting channel based on these driving values, thereby deriving the effective backlight color on each pixel.

In addition, the current per-pixel gamut for each pixel is calculated by accumulating light intensities from the plurality of light-emitting channels on each pixel to obtain the effective backlight color for each pixel. Due to the light diffusion characteristic, light received by a pixel comes not only from the LED directly behind the pixel but also includes light diffused from neighboring LEDs. The processor accumulates the light intensities from the plurality of light-emitting channels incident on each pixel, thereby obtaining a precise effective backlight color. Based on the effective backlight color, the current available gamut for that pixel (i.e., the current per-pixel gamut) may be derived.

In some implementations, the term “effective backlight color” describes the optical color composition received by each pixel, determined by the combined output of the plurality of light-emitting channels and their driving states. The computation and interpretation of the effective backlight color may differ depending on the display panel architecture:

For an LCD architecture with color filters: The effective backlight color at each pixel is determined by spatially mixing the light contributions from all active light-emitting channels (such as RGB or more), considering the effects of local dimming and optical diffusion. This spatially mixed color is then filtered by the associated color filter of each light modulation unit, so that the resulting per-pixel gamut is defined by both the incident spectral composition and the transmission property of the color filter.

For a field sequential display (FSD) without color filters: The effective backlight color refers to the temporally sequential color provided by the backlight at each field or sub-frame. At any specific time slot, typically only one color channel (e.g., red, green, or blue) is active, and the effective backlight color represents the spectral output during that period. In FSD, the per-pixel gamut is determined by the combination of the instantaneous effective backlight color and the transmittance of the liquid crystal unit, requiring dynamic calculation for each frame as the backlight color changes in time.

In both cases, the processor calculates the per-pixel gamut based on the effective backlight color, adapting the color compensation strategy according to the operating principles of the display architecture.

In step S220, the processor performs a pixel compensation operation on the plurality of pixels based on the current per-pixel gamut. In some implementations, the pixel compensation operation is performed by mapping the original color information from the reference color gamut to the current per-pixel gamut.

The pixel compensation operation may be realized through various computational methodologies and mechanisms, which are not limited to a particular form. By way of example and not limitation, such compensation may be executed using mathematical formulas, including but not limited to linear or nonlinear mapping functions, polynomial equations, or matrix transformations. Alternatively, compensation may be accomplished utilizing lookup tables (LUT), such as one-dimensional (1D) LUTs—for per-channel adjustment—or three-dimensional (3D) LUTs—for multidimensional color space transformation. In some embodiments, the processor may combine formulaic computations with LUT interpolation or extrapolation to achieve enhanced accuracy and computational efficiency.

It is expressly contemplated that the pixel compensation operation, as disclosed herein, is not limited to any specific algorithm or implementation and may incorporate any suitable mathematical, tabular, or software approach capable of effecting the desired mapping from the reference color gamut to the current per-pixel gamut.

In some implementations, after calculating the current per-pixel gamut for each pixel based on the effective backlight color received by each pixel in step S215 and before performing the pixel compensation operation in step S220, the processor determines whether the effective backlight color enables the current per-pixel gamut for each pixel to cover the original color information of the plurality of pixels within the input image data. Then, the processor adjusts the driving values of the plurality of light-emitting channels when the effective backlight color fails to enable the current per-pixel gamut to cover the original color information.

Specifically, after calculating a preliminary current per-pixel gamut, the processor collects color statistics of a target region of the input image data. Then, based on the color statistics, the processor determines whether a target effective backlight color formed by the current driving values enables the current per-pixel gamut of the pixels in the target region to effectively cover the original color information. When the target effective backlight color fails to enable the current per-pixel gamut to cover the original color information, the target region is identified as having a color shift risk. At this time, the processor adjusts the driving values corresponding to the target region and at least one adjacent region neighboring the target region. Due to the light diffusion characteristic, backlight from adjacent regions diffuses into the target region. Therefore, by adjusting or modifying the driving values of the adjacent regions (e.g., increasing the intensity of complementary colored light), the effective backlight color received by the target region may be effectively shifted, thereby expanding the formed gamut range to cover the original color information.

After the adjustment of the backlight driving values is completed, the originally calculated current per-pixel gamut is no longer accurate. Therefore, the processor recalculates an updated per-pixel gamut for the pixels within the target region based on the adjusted driving values of the plurality of light-emitting channels. Subsequently, the processor performs the pixel compensation operation based on the updated per-pixel gamut. By incorporating this mechanism, the present disclosure ensures that the final compensation operation is performed based on a corrected and sufficiently wide physical gamut, thereby eliminating color shift and achieving precise color reproduction.

In some implementations, after receiving the input image data and prior to calculating the current per-pixel gamut for each pixel, the processor analyzes color statistics of a target region within the input image data. In this embodiment, the processor aggregates information about the color requirements of all pixels within the target region, such as histogram distributions, average and maximum chromaticity values, or coverage boundaries in a color space. Based on these color statistics, the processor determines optimal driving values for the plurality of light-emitting channels in the backlight module, such as adjusting the intensity and ratio of each color channel (e.g., R, G, B, etc.).

The determined driving values are selected in order to ensure that the effective backlight color generated for the target region enables the current per-pixel gamut for all pixels within the region to encompass the original color information. By proactively setting the LED color and brightness profiles before per-pixel gamut calculation, the processor guarantees that the physical color gamut available for pixel compensation is sufficiently wide to cover the color demands of the input image data in the region.

For example, when the color statistics indicate that the region contains predominantly high saturation yellow and green pixels, the processor may increase the intensity of both the green and red channels in the backlight module, resulting in an enhanced yellowish effective backlight color. This proactive adjustment allows the gamut formed by the light modulation units in the region to sufficiently cover the input pixel color requirements without the need for iterative corrections after the initial gamut calculation.

After the backlight driving values are determined and applied according to the color statistics, the processor then calculates the current per-pixel gamut for each pixel based on the effective backlight color received, and performs the subsequent pixel compensation operation to accurately reproduce the image colors in the target region.

This embodiment enables the display device to dynamically adapt the backlight settings for different image regions, thereby effectively preventing color shift, maximizing color fidelity, and optimizing backlight utilization in accordance with the actual content of the displayed image.

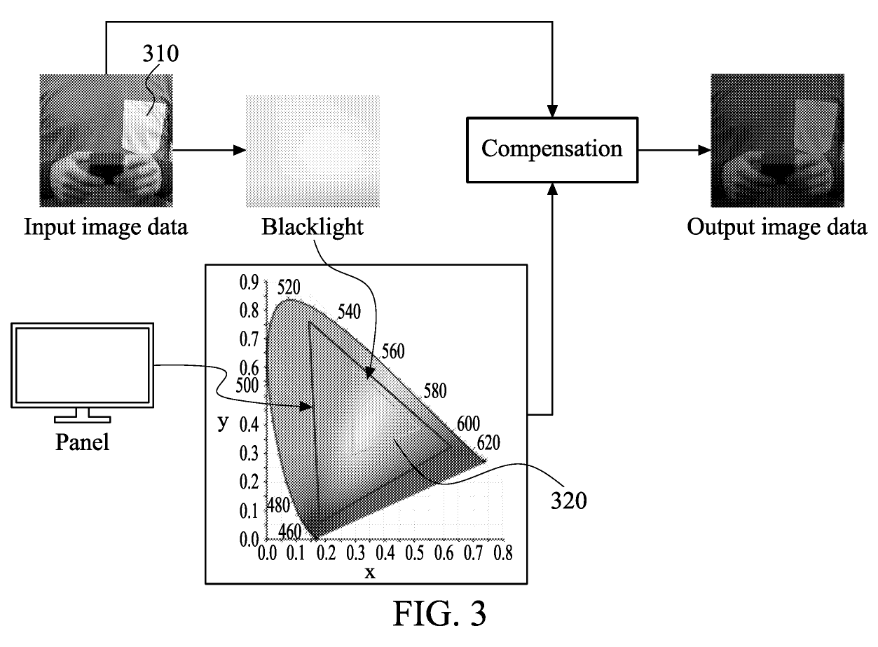

FIG. 3 is a schematic diagram illustrating an operational example of effective backlight color generation and gamut conversion in a backlight module comprising yellow and blue light-emitting channels in accordance with an implementation of the present disclosure.

In FIG. 3, the backlight module is configured with a number equal to 2, comprising a Blue Channel (B) and a Yellow Channel (Y). When the processor receives the input image data, the processor determines the backlight driving state for each region. Taking the white object 310 (e.g., the white pocket on the red shirt) in the input image data of FIG. 3 as an example, to define white on the display panel, the backlight module must provide light containing all necessary color components (e.g., red, green, and blue components). Therefore, in the region corresponding to the white object 310, the processor drives both the Blue channel and the Yellow channel. Since yellow light spectrally contains red and green components, when yellow light is mixed with blue light, a white backlight is synthesized. At this moment, the effective backlight color received by the pixels in this region is white, and the corresponding current per-pixel gamut exhibits a maximum range sufficient to reproduce the white color in the input image data.

Next, consider the red region (e.g., the red shirt) located at the periphery of the white object 310 in the input image. Since the backlight module in this embodiment is not equipped with independent red or green LEDs, to provide the red light required by the red color filters of the display panel, the processor must drive the Yellow channel. This is because the spectral composition of yellow light substantially includes both red light and green light. When the backlight emits yellow light and it passes through the red color filter of the display panel, the green component is filtered out, retaining only the red component, thereby allowing the pixel to display red.

Since light from each LED diffuses, the processor accumulates the light intensities from all light-emitting channels projected onto each pixel location. Thereby, the processor calculates the effective backlight color actually received by each pixel at the current time point, as shown in the backlight of FIG. 3.

Having obtained the effective backlight color for each pixel, the processor uses this information to determine the current per-pixel gamut for that pixel (as indicated by the triangle 320 in the chromaticity diagram of FIG. 3). This gamut represents the actual range of colors that the pixel may display with the current backlight combination. The subsequent pixel compensation operation is then performed based on this dynamically determined range.

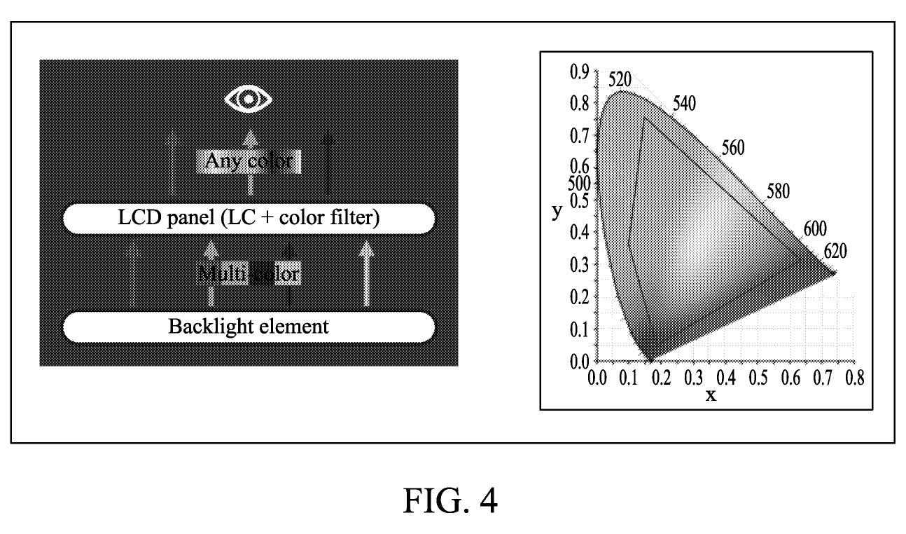

FIG. 4 is a schematic diagram illustrating a gamut expansion example utilizing a Red-Green-Blue-Cyan (RGBC) backlight module and an RGB display panel according to an embodiment of the present disclosure.

In this embodiment, the display panel maintains a standard configuration of Red, Green, and Blue (RGB) color filters (i.e., the number of the light modulation units is 3). However, the backlight module employs four light-emitting channels: Red, Green, Blue, and Cyan (C) (i.e., the number of the light-emitting channels is 4).

As shown in FIG. 4, in addition to the standard RGB triangular gamut, this embodiment significantly expands the gamut range of the display, particularly in the cyan hue region (the portion protruding to the left of the triangle in FIG. 4), by utilizing the additionally provided Cyan channel.

In conventional systems with only RGB backlights, displaying cyan requires simultaneously turning on the green and blue light-emitting channels to simulate cyan through color mixing. However, the spectral purity and saturation of cyan produced by mixing are often limited. In contrast, the backlight module of this embodiment may directly drive the Cyan channel to emit spectrally purer cyan light. This allows the boundary of the current per-pixel gamut to extend outward, covering high-saturation cyan regions that cannot be reached by conventional RGB mixing.

Combining the Yellow-Blue backlight embodiment of FIG. 3 and the RGBC backlight embodiment of FIG. 4, it is clear that the method for color compensation provided in the present disclosure has high universality. Regardless of the color combination used in the backlight module (e.g., R/G/B/C, B/Y, etc.) and regardless of the light modulation units configuration used in the display panel, as long as the number of light-emitting channels (i.e., backlight channels) is an integer greater than or equal to 2, the compensation mechanism based on per-pixel gamut estimation described in the present disclosure operates effectively to achieve optimized gamut utilization and precise color reproduction.

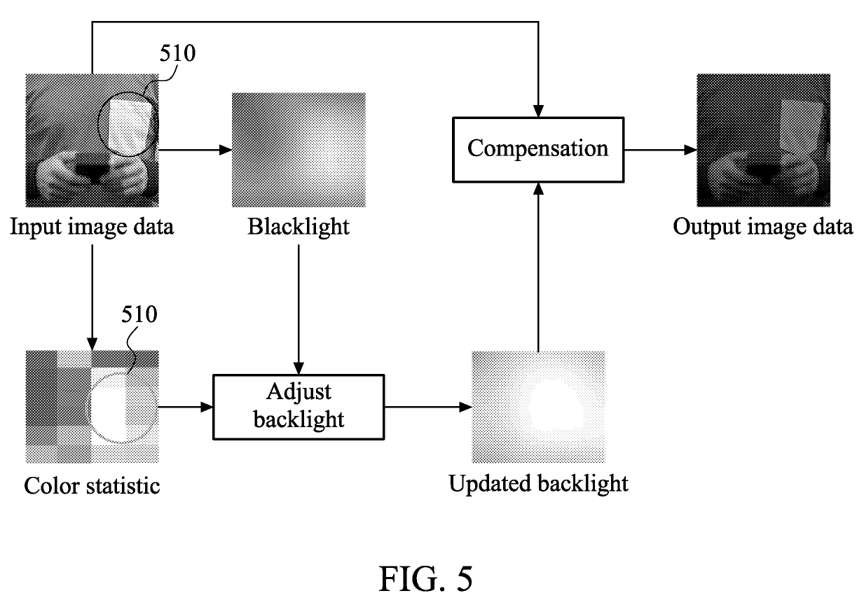

FIG. 5 is a schematic diagram illustrating the process of backlight adjustment and pixel compensation based on color statistics according to an embodiment of the present disclosure.

Referring to FIG. 5, take, for example, a scenario where the input image data contains a white object 510 (e.g., the circle area) immediately adjacent to a high-brightness red object (e.g., the red background). In the conventional backlight method, to satisfy the high brightness requirement of the red object, the backlight module is driven to emit high-intensity red light in that red region. However, due to the light diffusion characteristic, this red light diffuses into the adjacent region of the white object 510. When relying solely on conventional methods, the effective backlight received by the region of the white object 510 may exhibit a strong red deviation. Since red backlight lacks blue and green spectral components, even though the pixels of the liquid-crystal panel are fully open, this reddish backlight cannot be restored to the pure white required by the input data, resulting in a severe color shift.

The processor of the present disclosure first identifies the color shift risk in the white object 510 through color statistics. Next, the processor adjusts the backlight color of the target region corresponding to the white object 510 to shift towards white.

However, adjusting the backlight of the target region alone is often insufficient. This is because the light emission from each light-emitting channel (e.g., each LED) is not concentrated solely on its directly corresponding pixels but diffuses to affect a larger range. In other words, the light intensity received by a single pixel is formed by the joint contributions of the light-emitting channel directly behind it and the light-emitting channels of multiple surrounding adjacent regions.

To ensure that the target pixel receives a white light source of sufficient intensity, the processor not only needs to shift the target region towards white but also requires the nearby adjacent regions to contribute more white light (i.e., increasing the driving values of blue and green lights). Only when the backlight of the adjacent regions is also adjusted to shift towards white may the target pixel obtain sufficient and spectrally complete white light through the light intensity accumulation, thereby ensuring that the re-estimated current per-pixel gamut is sufficient to cover the white color in the input image data.

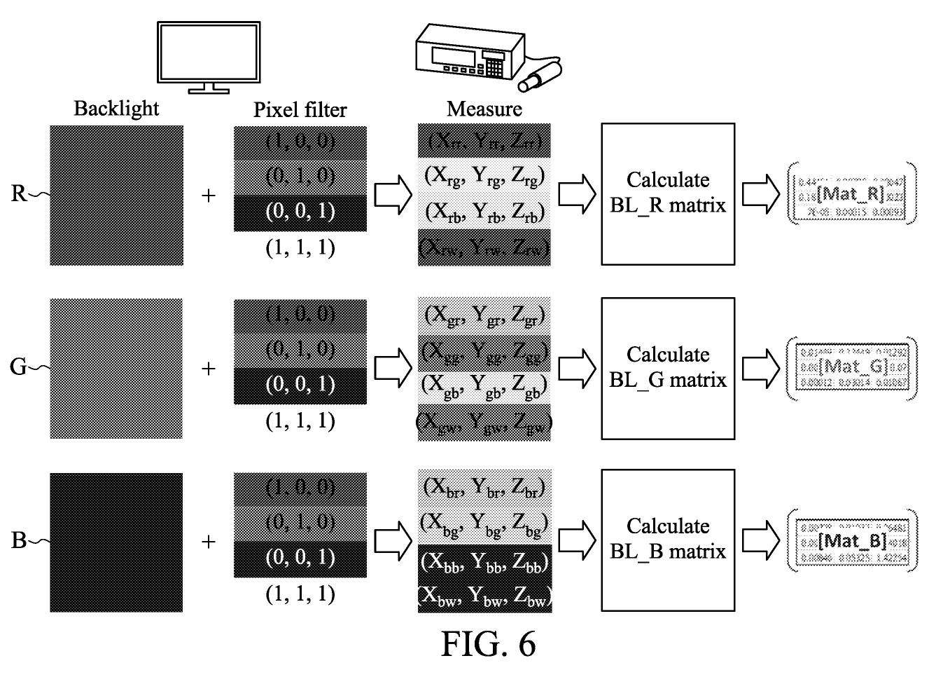

Next, to accurately calculate the current per-pixel gamut, the display device may first establish the color transformation relationship between the backlight module and the display panel, referred to as the color matrix. FIG. 6 is a schematic diagram illustrating the measurement process and calculation of color matrices for quantifying backlight and filter characteristics according to an embodiment of the present disclosure.

The color matrix serves to describe the actual physical representation of a color in an objective color space (e.g., the CIE XYZ chromaticity space) when the color is defined by multiple channels. Since color filters cannot perfectly isolate specific colors, a small amount of light from other colors inevitably leaks through and mixes together. For example, when the backlight module emits only red light (red backlight), although the red light primarily passes through the Red pixel filter, a faint amount of light actually leaks through the green pixel filter and the blue pixel filter.

As shown in FIG. 6, if the filters were perfect, red light passing through a green pixel filter should appear completely black. However, in actual physical measurement, faint "light green" or "light blue" light leakage is observed. This implies that the optical contribution of one unit of red backlight is not limited solely to the red channel (i.e., the matrix is not a simple [1, 0, 0]) but includes minute components of the green and blue channels.

In this embodiment, a professional luminance meter (or spectrometer) is utilized for measurement. First, the backlight is locked to a specific color (e.g., solid Red). Then, the states of the pixel filters (Red, Green, Blue, White) are switched sequentially, and their corresponding color measurement values (e.g., XYZ coordinates) are measured. Using this measured data, a red backlight matrix (BL_R Matrix) may be calculated. The values in this matrix quantify the actual light intensity contribution of one unit of red backlight to each of the R, G, and B channels. Similarly, by locking the backlight to green and blue respectively and performing measurements, a green backlight matrix (BL_G Matrix) and a blue backlight matrix (BL_B Matrix) may be established.

With these color matrices, which include the information about light leakage, the processor may accurately translate the LED driving values into actual color values. This calculation reveals the true gamut (color range) available at that moment, which is then used to perform the gamut mapping operation correctly.

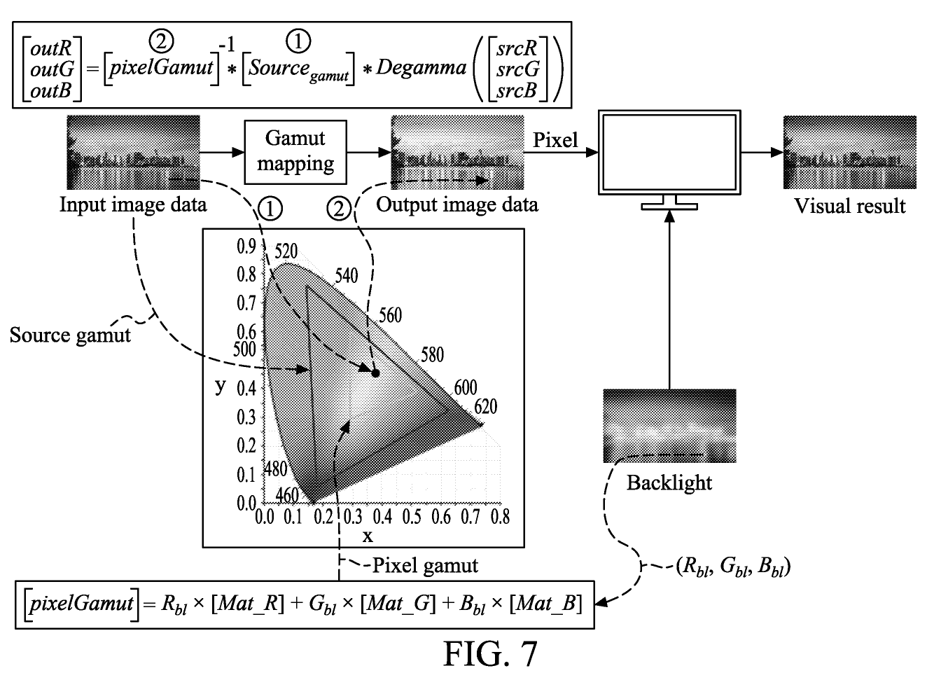

FIG. 7 is a schematic diagram illustrating the gamut mapping process based on source data and backlight target data according to an embodiment of the present disclosure.

Referring to FIG. 7, the pixel compensation operation of the present disclosure is achieved through a gamut mapping process. The core of this process relies on utilizing two sets of RGB information for conversion calculations.

The first set of information is referred to as source data (corresponding to path 1 in FIG. 7). This refers to the content that each pixel in the input image data intends to represent, i.e., the input RGB values. It represents the color that the pixel should display under a standard color space.

The second set of information is referred to as target data (corresponding to path 2 in FIG. 7). This refers to the color capability that the pixel can actually display at the current time point after receiving the effective backlight color from the backlight module. Since the color of the backlight directly influences the final visual result perceived by the human eye, this data represents the color basis (i.e., pixel gamut) provided by the current backlight environment.

The processor maps the color required by the source data into the color range defined by the target data based on these two sets of RGB data. Simply put, the processor calculates what values (outR, outG, outB) the display panel needs to output under the current backlight conditions so that the final visual result accurately restores the original appearance of the input image.

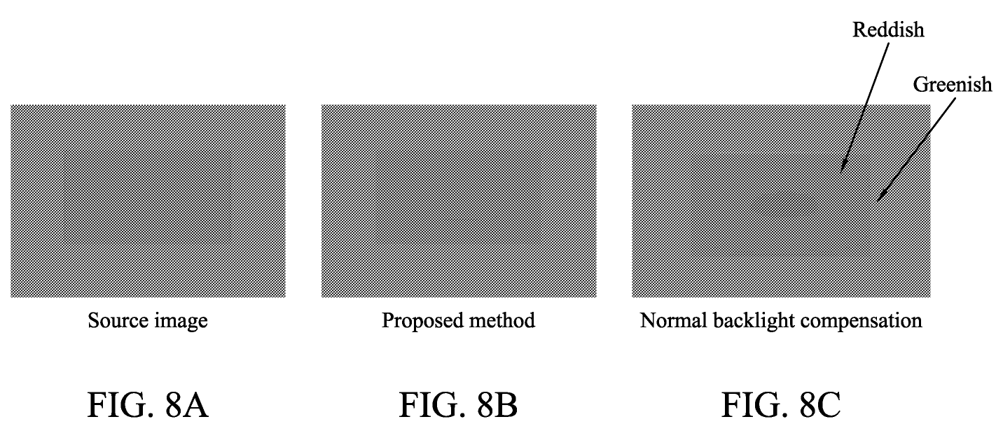

FIGS. 8A-8C are schematic diagrams illustrating a comparison of simulation results between a source image, an image processed by the proposed method for color compensation, and an image processed by a normal backlight compensation method in accordance with an implementation of the present disclosure.

"Color Shift" is defined as a discrepancy where the output color, after compensation operations, fails to accurately restore the known input data. As shown in the normal backlight compensation of FIG. 8C, without utilizing the mechanism of the present disclosure, the central region, which is originally yellow, exhibits a reddish hue; meanwhile, the background region, which should be pure gray (i.e., R = G = B), exhibits a greenish hue. This indicates a failure of the compensation to accurately offset the interaction between the backlight and the color filters.

In contrast, the proposed method compensation of FIG. 8B shows that the color shift phenomena are significantly improved when the method for color compensation based on gamut mapping and backlight adjustment proposed by the present disclosure is adopted. The color performance of the output image is substantially identical to the source image of FIG. 8A, wherein the yellow region is accurately restored as yellow, and the gray background is also maintained as gray. This result confirms that the present disclosure ensures the final displayed visual color is consistent with the original input data, effectively eliminating color shift problems common in conventional techniques.

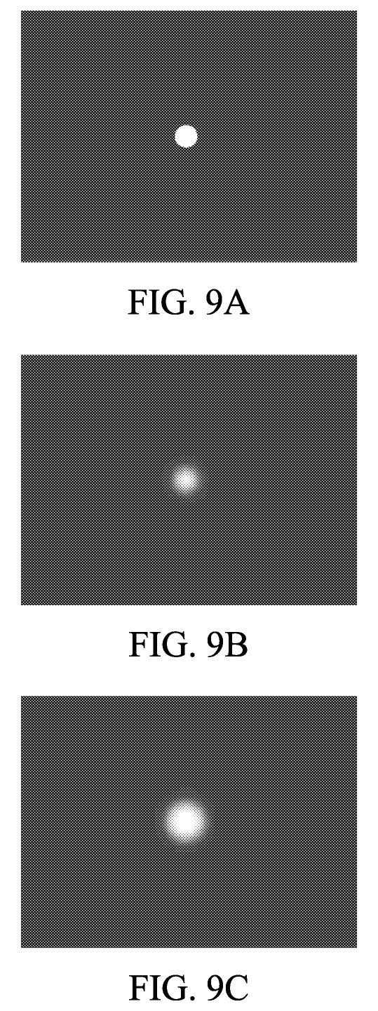

FIGS. 9A-9C illustrate the effects achieved by applying the method for color compensation in accordance with an implementation of the present disclosure. Specifically, FIG. 9A represents an original input image, which is the target display data intended to be presented. In a scenario where the backlight source exhibits a specific color (e.g., a pink light source as shown in FIG. 9B), it may result in color deviation in the final displayed image. Since the method of the present invention has pre-considered the color characteristics of the light source and performed compensation processing, the interference caused by the light source color can be effectively neutralized, thereby restoring the display image to its correct colors, as shown in FIG. 9C.

In summary, the present disclosure provides a method for color compensation applied to multi-color backlight display devices. By utilizing the measured color matrices to account for light leakage, the present disclosure may accurately calculate the actual color range that each pixel is capable of displaying under the current backlight conditions.

To address color shift risks caused by insufficient local backlight color (e.g., red backlight diffusion causing adjacent white regions to appear reddish), the processor of the present disclosure not only adjusts the backlight of the target region but also cooperatively controls the light-emitting channels of adjacent regions to inject compensating colored light (e.g., increasing blue and green light to synthesize white light). It then recalculates the updated gamut in real-time to execute the final gamut mapping.

This method provided in the present disclosure not only resolves color accuracy issues during the light mixing process of multi-color backlights (such as B+Y or RGBC) but also effectively utilizes independent color channels (such as cyan) to expand the display gamut. Simulation results confirm that the present disclosure ensures the final output visual color is highly consistent with the original input data, achieving superior display quality with high saturation and no color shift.

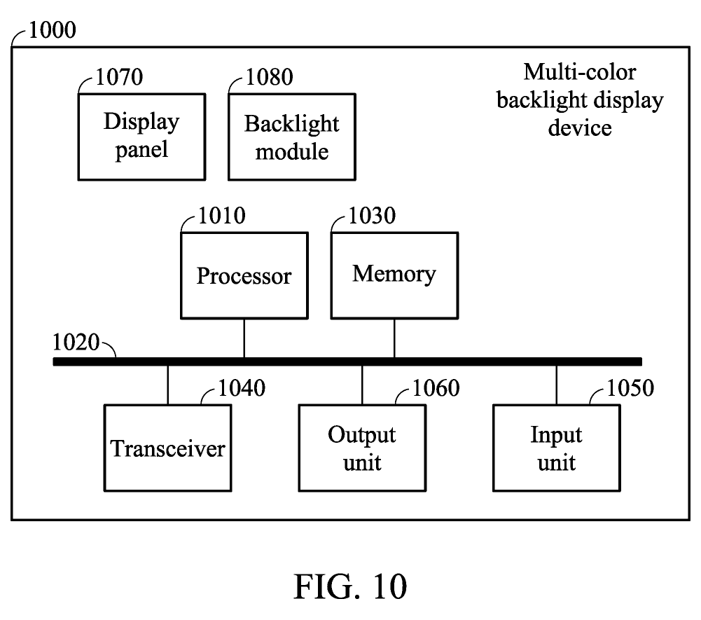

The present disclosure provides in an alternative embodiment a multi-color backlight display device, as shown in FIG. 10, the multi-color backlight display device 1000 shown in FIG. 10 including: a processor 1010 and a memory 1030. The processor 1010 and the memory 1030 are electrically coupled, such as via bus 1020, among other things.

The multi-color backlight display device 1000, to which the present invention is directed, is configured with a backlight module comprising a plurality of light-emitting channels capable of generating multiple distinct colors. The multi-color backlight display device 1000 is not limited to any specific display panel structure, provided that the backlight module enables multi-color illumination. For example, the display device 1000 may include, but is not limited to: a liquid crystal display (LCD) having a multi-color LED backlight module, such as RGB, RGBW, RGGB, or other multi-wavelength LED arrangements; an LCD panel equipped with mini-LED or micro-LED backlight modules, wherein the backlight is arranged in independently controllable zones capable of emitting different colors; a field sequential display (FSD) or field sequential color display (FSC), wherein color rendering is achieved by sequentially illuminating the panel with independently controlled colored light fields from the multi-color backlight module; a quantum dot enhanced display (QLED) utilizing quantum dots in combination with multi-color LED excitation sources to provide a wide-gamut multi-color backlight; advanced display technologies employing pixel-wise or area-wise controllable multi-color backlight modules, including automotive, head-up, AR/VR, flexible, transparent, or wearable displays, provided that the backlight comprises a plurality of independently driven light-emitting channels for multi-color illumination.

The processor 1010 may be a CPU (Central Processing Unit), general purpose Processor, DSP (Digital Signal Processor), ASIC (Application Specific Integrated Circuit), FPGA (Field Programmable Gate Array), or other Programmable logic device, transistor logic, hardware component, or any combination thereof. Which may implement or execute the various illustrative logical blocks, modules, and circuits described in connection with the disclosure. The processor 1010 may also be a combination of computing functions, e.g., including one or more microprocessors, DSPs and microprocessors, and the like.

The bus 1020 may include a path that conveys information between the aforementioned components. The bus 1020 may be a PCI (Peripheral Component Interconnect) bus, an EISA (Extended Industry Standard Architecture) bus, or the like. The bus 1020 may be divided into an address bus, a data bus, a control bus, and so on. For ease of illustration, only one thick line is shown in FIG. 10, but that does not indicate only one bus or one type of bus.

The memory 1030 may be a ROM (Read-Only Memory) or other type of static storage device that can store static information and instructions, a RAM (random access Memory) or other type of dynamic storage device that can store information and instructions, an EEPROM (Electrically Erasable Programmable Read-Only Memory), a CD-ROM (Compact disk Read-Only Memory) or other optical disk storage, optical disk storage (including Compact disk, laser disk, optical disk, digital versatile disk, Blu-ray disk, etc.), a magnetic disk storage medium or other magnetic storage device, or any other medium that can be used to carry or store desired program code in the form of instructions or data structures and that can be accessed by a computer, but is not limited to such.

Optionally, the display device 1000 may also include a transceiver 1040. The transceiver 1040 may be used for reception and transmission of signals. The transceiver 1040 may allow the display device 1000 to communicate with other devices wirelessly or by wire to exchange data. It should be noted that the transceiver 1040 is not limited to one in practice.

Optionally, the multi-color backlight display device 1000 may further include an input unit 1050. The input unit 1050 may be used to receive input numeric, character, image, and/or sound information, or to generate key signal inputs related to user settings and function control of the multi-color backlight display device 1000. The input unit 1050 may include, but is not limited to, one or more of a touch screen, a physical keyboard, function keys (such as volume control keys, switch keys, etc.), a trackball, a mouse, a joystick, a camera, a microphone, and the like.

Optionally, the multi-color backlight display device 1000 may further include an output unit 1060. The output unit 1060 may be used to output or show information processed by processor 1010. The output unit 1060 may include, but is not limited to, one or more of a display device, a speaker, a vibration device, and the like.

The multi-color backlight display device 1000 may further include a display panel 1070 and a backlight module 1080, the display panel 1070 being divided into a plurality of display subareas, and the backlight module 1080 including a plurality of backlight subareas, the display subareas and the backlight subareas being in one-to-one correspondence.

While FIG. 10 illustrates a multi-color backlight display device 1000 having various means, it is to be understood that not all illustrated means are required to be implemented or provided. More or fewer devices may be alternatively implemented or provided.

Optionally, the memory 1030 is used to store at least one program for performing the disclosed aspects and is controlled in execution by the processor 1010. The processor 1010 is configured to execute at least one program stored in the memory 1030 to implement any one of the color compensation methods provided by the embodiments of the present disclosure.

It should be noted that the division of each module is only a logical division, and all or part of the actual implementation may be integrated into one physical entity or may be physically separated. And these modules can all be implemented in the form of software invoked by a processing element, or can be implemented in the form of hardware, and part of the modules can be realized in the form of calling software by the processing element, and part of the modules can be realized in the form of hardware. For example, the determining module may be a processing element separately set up, or may be integrated into a chip of the apparatus, or may be stored in a memory of the apparatus in the form of program code, and a processing element of the apparatus calls and executes the function of the determining module. The other modules are implemented similarly. In addition, all or part of the modules can be integrated together or can be realized. The processing element described herein may be an integrated circuit having signal processing capabilities. In implementation, each step of the above method or each module above may be implemented by an integrated logic circuit of hardware in a processor element or an instruction in the form of software.

For example, the various modules, units, sub-units, or sub-modules may be one or more integrated circuits configured to implement the above methods, such as: one or more Application Specific Integrated Circuits (ASICs), one or more microprocessors (DSPs), or one or more Field Programmable Gate Arrays (FPGAs), among others. For another example, when some of the above modules are implemented in the form of a processing element scheduler code, the processing element may be a general-purpose processor, such as a Central Processing Unit (CPU) or other processor that can call the program code. As another example, these modules may be integrated together and implemented in the form of a system-on-a-chip (SOC).

It should be understood that any specific order or hierarchy of steps in any disclosed process is an example of a sample approach. Based upon design preferences, it should be understood that the specific order or hierarchy of steps in the processes may be rearranged while remaining within the scope of the present disclosure. The accompanying method claims present elements of the various steps in a sample order, and are not meant to be limited to the specific order or hierarchy presented.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having the same name (but for use of the ordinal term) to distinguish the claim elements.

While the disclosure has been described by way of example and in terms of the preferred embodiments, it should be understood that the disclosure is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method for color compensation in a multi-color backlight display device, wherein the multi-color backlight display device comprises a display panel and a backlight module, the backlight module comprises a plurality of light-emitting channels and the display panel has a plurality of light modulation units, the method comprising:
obtaining a reference color gamut of the display panel;
receiving input image data containing original color information of a plurality of pixels;
calculating a current per-pixel gamut for each pixel based on an effective backlight color received by each pixel, wherein the effective backlight color corresponds to driving values of the plurality of light-emitting channels; and
performing a pixel compensation operation on the plurality of pixels based on the current per-pixel gamut.

2. The method of claim 1, wherein the reference color gamut is obtained based on the plurality of light modulation units of the display panel being illuminated by the plurality of light-emitting channels of the backlight module.

3. The method of claim 1, wherein the pixel compensation operation is performed by mapping the original color information from the reference color gamut to the current per-pixel gamut.

4. The method of claim 1, wherein after calculating the current per-pixel gamut for each pixel based on the effective backlight color received by each pixel and before performing the pixel compensation operation, the method further comprises:
determining whether the effective backlight color enables the current per-pixel gamut for each pixel to cover the original color information of the plurality of pixels within the input image data; and
adjusting the driving values of the plurality of light-emitting channels when the effective backlight color fails to enable the current per-pixel gamut to cover the original color information.

5. The method of claim 4, wherein the step of adjusting the driving values of the plurality of light-emitting channels further comprises:
collecting color statistics of a target region of the input image data;
identifying the target region in which a target effective backlight color fails to enable the current per-pixel gamut to cover the original color information based on the color statistics; and
adjusting the driving values corresponding to the target region and at least one adjacent region neighboring the target region.

6. The method of claim 5, further comprising:
calculating an updated per-pixel gamut for the pixels within the target region based on the adjusted driving values of the plurality of light-emitting channels; and
performing the pixel compensation operation based on the updated per-pixel gamut.

7. The method of claim 1, wherein the step of calculating the current per-pixel gamut for each pixel comprises:
accumulating light intensities from the plurality of light-emitting channels on each pixel to obtain the effective backlight color for each pixel.

8. The method of claim 1, wherein after receiving input image data and before calculating the current per-pixel gamut for each pixel, the method further comprises:
analyzing color statistics of a target region of the input image data, and determining driving values for the plurality of light-emitting channels of the backlight module based on the color statistics, in order to enable the current per-pixel gamut for pixels in the target region to cover the original color information of the pixels within the region.

9. The method of claim 1, wherein each light modulation unit includes a corresponding color filter, and the display panel further comprises a plurality of color filter channels.

10. The method of claim 1, wherein the display device is a field sequential display (FSD), and the plurality of light-emitting channels are configured to emit different colors sequentially in time.

11. A multi-color backlight display device, wherein the multi-color backlight display device comprises a display panel and a backlight module, the backlight module comprises a plurality of light-emitting channels, and the display panel has a plurality of light modulation units, wherein the multi-color backlight display device further comprises:
a memory; and
at least one processor coupled to the memory, wherein the at least one processor performs operations comprising:
obtaining a reference color gamut of the display panel;
receiving input image data containing original color information of a plurality of pixels;
calculating a current per-pixel gamut for each pixel based on an effective backlight color received by each pixel, wherein the effective backlight color corresponds to driving values of the plurality of light-emitting channels; and
performing a pixel compensation operation on the plurality of pixels based on the current per-pixel gamut.

12. The multi-color backlight display device of claim 11, wherein the reference color gamut is obtained based on the plurality of light modulation units of the display panel being illuminated by the plurality of light-emitting channels of the backlight module.

13. The multi-color backlight display device of claim 11, wherein the pixel compensation operation is performed by mapping the original color information from the reference color gamut to the current per-pixel gamut.

14. The multi-color backlight display device of claim 11, wherein after calculating the current per-pixel gamut for each pixel based on the effective backlight color received by each pixel and before performing the pixel compensation operation, the processor is further configured to perform operations comprising:
determining whether the effective backlight color enables the current per-pixel gamut for each pixel to cover the original color information of the plurality of pixels within the input image data; and
adjusting the driving values of the plurality of light-emitting channels when the effective backlight color fails to enable the current per-pixel gamut to cover the original color information.

15. The multi-color backlight display device of claim 14, wherein, in adjusting the driving values of the plurality of light-emitting channels, the processor is further configured to perform operations comprising:
collecting color statistics of a target region of the input image data;
identifying the target region in which a target effective backlight color fails to enable the current per-pixel gamut to cover the original color information based on the color statistics; and
adjusting the driving values corresponding to the target region and at least one adjacent region neighboring the target region.

16. The multi-color backlight display device of claim 15, wherein the processor is further configured to perform operations comprising:
calculating an updated per-pixel gamut for the pixels within the target region based on the adjusted driving values of the plurality of light-emitting channels; and
performing the pixel compensation operation based on the updated per-pixel gamut.

17. The multi-color backlight display device of claim 11, wherein, in calculating the current per-pixel gamut for each pixel, the processor is further configured to perform operations comprising:
accumulating light intensities from the plurality of light-emitting channels on each pixel to obtain the effective backlight color for each pixel.

18. The multi-color backlight display device of claim 11, wherein after receiving input image data and before calculating the current per-pixel gamut for each pixel, the processor is further configured to perform operations comprising:
analyzing color statistics of a target region of the input image data, and determining driving values for the plurality of light-emitting channels of the backlight module based on the color statistics, in order to enable the current per-pixel gamut for pixels in the target region to cover the original color information of the pixels within the region.

19. The multi-color backlight display device of claim 11, wherein each light modulation unit includes a corresponding color filter, and the display panel further comprises a plurality of color filter channels.

20. The multi-color backlight display device of claim 11, wherein the display device is a field sequential display (FSD), and the plurality of light-emitting channels are configured to emit different colors sequentially in time.
